(19) United States
(12) Patent Application Publication
(10) Pub. No.: US 2021/0097606 A1
(43) Pub. Date: Apr. 1, 2021

(54) ONLINE VEHICLE SUBSCRIPTION SERVICE INCLUDING AN AUTOMATED CREDIT CHECK FUNCTION

(71) Applicant: Volvo Car Corporation, Göteborg (SE)

(72) Inventors: Douglas Robert CASE, Saratoga, CA (US); Stephen Beck SUNDQUIST, Newark, CA (US); Warren DAVIDSON, Göteborg (SE)

(21) Appl. No.: 16/587,115

(22) Filed: Sep. 30, 2019

(51) Int. Cl. G06Q 40/02; G06N 20/00

(52) U.S. Cl. CPC G06Q 40/025; G06N 20/00

(57) ABSTRACT

A method of enabling a user to subscribe to, lease, or purchase an asset or asset service using an application, the method including: receiving user and asset information via the application; receiving credit check information via the application; based on the user, asset, and credit check information, via a customer service organization link, designating the user as one status of “approved”, “denied”, and “maybe”; in the event of a “denied” or “maybe” status designation, requesting additional user information via the application or manually or automatically taking a dynamic rule action to change the status designation to “approved” in a systematic manner based on the additional user information or dynamic rule action; and notifying the user of the status designation via the application.

### TECHNICAL FIELD

The present disclosure relates generally to the automotive and software fields. More particularly, the present disclosure relates to an online vehicle subscription service (or other like financial or business transaction involving an asset or asset service) including an automated credit check function.

### BACKGROUND

A credit check is an important part of an automotive subscription, automotive lease, or automotive purchase that is wholly or partly financed. In fact, a credit check is an important part of many financial and business transactions, not just in the automotive field. Thus, while the present disclosure relates to the implementation of automated credit checks in the automotive field, and examples are provided within that context, the concepts outlined could apply to automated credit checks in other fields as well.

Many automotive manufacturers now provide automated or semi-automated subscription, lease, or purchase services. However, the automotive field in general and credit checks specifically are heavily regulated, which can make providing such automated or semi-automated processing options considerably more difficult. Various regulations can effectively cause complications and mandate exceptions or special handling requirements in many different circumstances.

Prior subscription, lease, or purchase processing has not typically included an automated credit check step. Rather, there has been only automated processing for selecting a vehicle and for specifying information about the user. To date, credit checks have been manual processes that have involved a customer support organization that has often telephoned users to ask them questions or asked users to exchange information with the customer support organization via facsimile or email. The customer support organization would then send the appropriate information to some accredited financial partner who would then perform the actual credit check based on the information available. This typically takes a number of days. This delay has caused a lot of business to be lost since when users have await a decision over an extended period of time they often lose interest, change their minds, or find another solution for their needs.

Thus, the present disclosure provide an online subscription, lease, or purchase processing system that includes an automated or semi-automated credit check function. The present disclosure finds applicability in the automotive, as well as other, fields. The credit check function of the present disclosure serves to achieve a “yes” credit decision in most cases, even if a “maybe” or “no” credit decision is initially indicated, through the iterative use of dynamically prioritized rules, thereby enhancing business value. These dynamically prioritized rules are usually applied synchronously, enabling revised decisions to be made very rapidly usually without revised user inputs, without the explicit awareness of the user, thereby also enhancing business value. This prevents customers from taking their business elsewhere responsive to a credit check function that is inflexible, overly complex and time-consuming, and annoying.

### SUMMARY

Implementing an automated credit check function is problematic due to the various financial guidelines and legal regulations involved, however, the present disclosure provides a straightforward and industry-standard approach that can be used to render a credit check “yes” decision in most or many cases. Initially, there are a few different versions of “no” and “maybe”. There are vendors with application programming interface (API) offerings specifically tailored to take the local financial guidelines and legal regulations into account. A product or service can call on one of these API offerings with data gathered from users to get a “yes” decision from the API on the credit check. Advantageously, this credit check function is performed substantially synchronously. Practically, approving more credit applications is beneficial in that it generates more business for an implementer. In the event of a “maybe” or even a “no” credit decision, the present disclosure iteratively applies certain rules in a prioritized order to get to a “yes” credit decision, maximizing the business value from a credit application.

In general, the present disclosure provides, in the event of a “maybe” or “no” credit decision, dynamically requesting stipulations that are guided by feedback from existing contracts (potentially analyzed utilizing a machine learning (ML) methodology or the like) or other business directives and/or considerations. A dynamic follow-up or counter-offer is thereby provided, representing one or more rules that are implemented in a prioritized order based on which will yield the greatest value. Some factors that may be considered include the location of the applicant, the financial condition and credit worthiness of the applicant based on bank information, for example, and the price and available inventory of the desired good (e.g., vehicle) or service. Exemplary dynamic counter-offers include, but are not limited to, increased collateral or lowered capitalized amount to lower risk (e.g., increased up-front/down-payment, co-signer or additional applicant, lower pre-approval amount, additional collateral assets) and verifying identity/financial information (e.g., through a verification provider or by providing bank access or uploading bank documents), representing income verification, income-to-expense ratio/trends, and/or income/debt ratio. Finally, a “maybe” loan can be “vended out” to a third party better equipped and more willing to handle it, as an option to defer or reduce risk.

Thus, the present disclosure provide an online subscription, lease, or purchase processing system that includes an automated or semi-automated credit check function. The present disclosure finds applicability in the automotive, as well as other, fields. The credit check function of the present disclosure serves to achieve a “yes” credit decision in most cases, even if a “maybe” or “no” credit decision is initially indicated, through the iterative use of dynamically prioritized rules, thereby enhancing business value. These dynamically prioritized rules are usually applied synchronously, enabling revised decisions to be made very rapidly usually without revised user inputs, without the explicit awareness of the user, thereby also enhancing business value. This prevents customers from taking their business elsewhere responsive to a credit check function that is inflexible, overly complex and time-consuming, and annoying.

In one exemplary embodiment, the present disclosure provides a method of enabling a user to subscribe to, lease, or purchase an asset or asset service using an application (i.e., a software or web application), the method including: receiving user and asset information via the application; receiving credit check information via the application; based on the user, asset, and credit check information, via a customer service organization link (i.e., a communication link), designating the user as one status of “approved”, “denied”, and “maybe”; in the event of a “denied” or “maybe” status designation, optionally (infrequently) requesting additional user information via the application or manually or automatically taking a dynamic rule action to change the status designation to “approved” in a systematic manner based on the additional user information or dynamic rule action; and notifying the user of the status designation via the application. The user information includes one or more of personal identification information, insurance information, and banking information (depending upon the jurisdiction). The credit check information includes one or more of financial information and jurisdiction information. In the event of the “denied” or “maybe” status designation, requesting the additional user information via the application includes one or more of requesting additional user identification information, requesting additional user financial information, and requesting access to one or more user financial accounts. In the event of the “denied” or “maybe” status designation, manually or automatically taking the rule action includes one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination. Preferably, the designating step is performed synchronously and, optionally, monitored using a visual progress indicator displayed in the application.

In another exemplary embodiment, the present disclosure provides a non-transitory computer-readable medium stored in a memory and executed by a processor to perform steps for enabling a user to subscribe to, lease, or purchase an asset or asset service using an application (i.e., a software or web application), the steps including: receiving user and asset information via the application; receiving credit check information via the application; based on the user, asset, and credit check information, via a customer service organization link (i.e., a communication link), designating the user as one status of “approved”, “denied”, and “maybe”; in the event of a “denied” or “maybe” status designation, optionally (infrequently) requesting additional user information via the application or manually or automatically taking a dynamic rule action to change the status designation to “approved” in a systematic manner based on the additional user information or dynamic rule action; and notifying the user of the status designation via the application. The user information includes one or more of personal identification information, insurance information, and banking information (depending upon the jurisdiction). The credit check information includes one or more of financial information and jurisdiction information. In the event of the “denied” or “maybe” status designation, requesting the additional user information via the application includes one or more of requesting additional user identification information, requesting additional user financial information, and requesting access to one or more user financial accounts. In the event of the “denied” or “maybe” status designation, manually or automatically taking the rule action includes one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination. Preferably, the designating step is performed synchronously and, optionally, monitored using a visual progress indicator displayed in the application.

In a further exemplary embodiment, the present disclosure provides a system for enabling a user to subscribe to, lease, or purchase an asset or asset service using an application (i.e., a software or web application), the system including: a subscription module executed by a processor operable for receiving user and asset information via the application; a credit check module executed by the processor operable for receiving credit check information via the application; a customer service organization link (i.e., a communication link) operable for, based on the user, asset, and credit check information, designating the user as one status of “approved”, “denied”, and “maybe”; in the event of a “denied” or “maybe” status designation, the credit check module further operable for optionally (infrequently) requesting additional user information via the application or manually or automatically taking a dynamic rule action to change the status designation to “approved” in a systematic manner based on the additional user information or dynamic rule action; and display/communication means operable for notifying the user of the status designation via the application. The user information includes one or more of personal identification information and insurance information (depending upon the jurisdiction). The credit check information includes one or more of financial information and jurisdiction information. In the event of the “denied” or “maybe” status designation, requesting the additional user information via the application includes one or more of requesting additional user identification information, requesting additional user financial information, and requesting access to one or more user financial accounts. In the event of the “denied” or “maybe” status designation, manually or automatically taking the rule action includes one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination. Preferably, the designating step is performed synchronously and, optionally, monitored using a visual progress indicator displayed in the application.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram illustrating one exemplary embodiment of the vehicle subscription, lease, or purchase application of the present disclosure, including the credit check module of the present disclosure;

FIG. 2 is a schematic diagram illustrating a “soft reject” flow utilized by the credit check module of the present disclosure;

FIG. 3 is another schematic diagram illustrating a “soft reject” flow utilized by the credit check module of the present disclosure; and

FIG. 4 is a further schematic diagram illustrating a “soft reject” flow utilized by the credit check module of the present disclosure.

### DESCRIPTION OF EMBODIMENTS

The implementing of an automated credit check function is problematic due to the various financial guidelines and legal regulations involved, however, the present disclosure provides a straightforward and industry-standard approach that can be used to render a credit check “yes” decision in most or many cases. Initially, there are a few different versions of “no” and “maybe”. There are vendors with application programming interface (API) offerings specifically tailored to take the local financial guidelines and legal regulations into account. A product or service can call on one of these API offerings with data gathered from users to get a “yes” decision from the API on the credit check. Advantageously, this credit check function is performed substantially synchronously. Practically, approving more credit applications is beneficial in that it generates more business for an implementer. In the event of a “maybe” or even a “no” credit decision, the present disclosure iteratively applies certain rules in a prioritized order to get to a “yes” credit decision, maximizing the business value from a credit application.

Thus, the present disclosure provides an online subscription, lease, or purchase processing system that includes an automated or semi-automated credit check function. The present disclosure finds applicability in the automotive, as well as other, fields. The credit check function of the present disclosure serves to achieve a “yes” credit decision in most cases, even if a “maybe” or “no” credit decision is initially indicated, through the iterative use of dynamically prioritized rules, thereby enhancing business value. These dynamically prioritized rules are usually applied synchronously, enabling revised decisions to be made very rapidly usually without revised user inputs, without the explicit awareness of the user, thereby also enhancing business value. This prevents customers from taking their business elsewhere responsive to a credit check function that is inflexible, overly complex and time-consuming, and annoying.

In general, the present disclosure provides, in the event of a “maybe” or “no” credit decision, dynamically requesting stipulations that are guided by feedback from existing contracts (potentially analyzed utilizing a machine learning (ML) methodology or the like) or other business directives and/or considerations. A dynamic follow-up or counter-offer is thereby provided, representing one or more rules that are implemented in a prioritized order based on which will yield the greatest value. Some factors that may be considered include the location of the applicant, the financial condition and credit worthiness of the applicant based on bank information, for example, and the price and available inventory of the desired good (e.g., vehicle) or service. Exemplary dynamic counter-offers include, but are not limited to, increased collateral or lowered capitalized amount to lower risk (e.g., increased up-front/down-payment, co-signer or additional applicant, lower pre-approval amount, additional collateral assets) and verifying identity/financial information (e.g., through a verification provider or by providing bank access or uploading bank documents), representing income verification, income-to-expense ratio/trends, and/or income/debt ratio. Finally, a “maybe” loan can be “vended out” to a third party better equipped and more willing to handle it, as an option to defer or reduce risk.

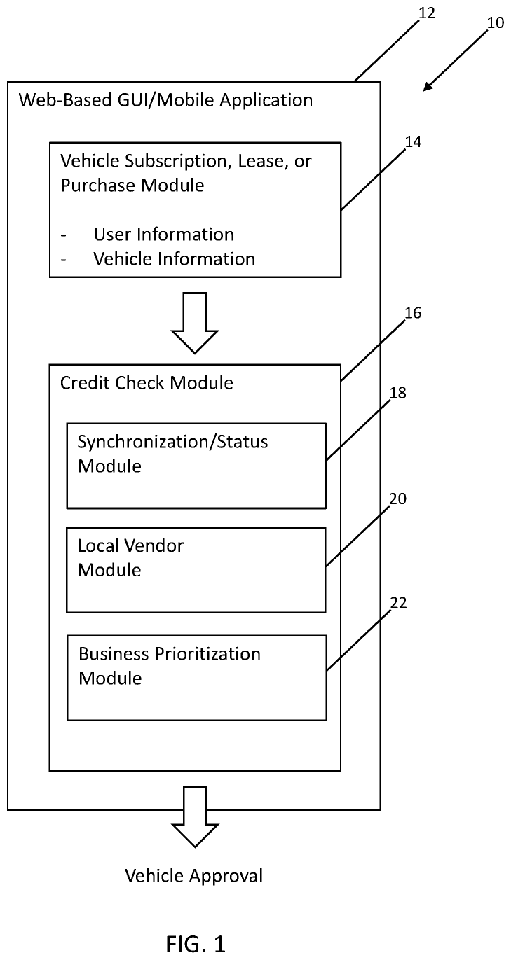

Referring now specifically to FIG. 1, in one exemplary embodiment, the vehicle subscription, lease, or purchase application 10 of the present disclosure is implemented via a browser and web-based graphical user interface (GUI) or mobile application 12 that executes a vehicle subscription, lease, or purchase module 14, well known to persons of ordinary skill in the art, that is generally operable for obtaining personal and vehicle preference information from a user such that the user can ultimately be provided a vehicle or vehicle service. Here, the GUI 12 also executes a credit check module 16 that includes a synchronization/status module 18, a local vendor module 20, and a business prioritization module 22, each of which forms a key aspect of the present disclosure. In general, the credit check module 16 allows the user to perform a credit check and become financially qualified for the vehicle subscription, lease, or purchase of interest. The synchronization/status module 18 allows the user to enter information and receive decisions within only seconds or minutes, such that the whole decision-making process occurs substantially in real time. When an offline delay is required, the synchronization/status module 18 allows the user to leave and return to the process seamlessly, via a notification email or text and a process status page or bar, indicating the user's progress in the process, preferably at all times. The local vendor module 20 allows local vendors to be queried for financing options and decisions, especially in “maybe” cases. The business prioritization module 22 automatically provides an ordered list of requirements or options to convert from a “no” decision or a “maybe” decision to a “yes” decision, taking into account various business factors. Each of these functionalities is described in greater detail herein below.

Related to the synchronization/status module 18, conventionally, the subscription flow in general, and the credit check flow which is a subset of it, are not always synchronous. That is, there may be situations or conditions where for some users or some situations a successful flow through the whole process can occur “synchronously”—that is, with the time between screens/pages within the GUI 12 (or mobile app) taking a few seconds at most. In such scenario, a user can just proceed from start to finish in one sitting, without ever having to wait for annoying amounts of time (i.e., more than a few seconds). There are, however, inherently some scenarios where offline processing must be done, typically by the customer support organization. In that case, it is assumed that the user must go offline for some time, and then somehow “come back” into the flow later. Care must be taken to make sure that the user comes back into the flow seamlessly, into the right place in the flow. This is done with a combination of emails or texts to the user, and/or an overall “status page” that the user can access in the GUI or mobile app 12 that will bring the user to the correct place in the flow. This makes the user experience feel like things are reasonably seamless or synchronous, even when it is not really synchronous, even when there has been a significant delay for some financial operation. Since some of these financial credit check operations are inherently slow, doing things seamlessly is beneficial. Since the credit check process has historically been an asynchronous operation done with old technologies like the telephone, faxes, emails, now having automated GUIs or mobile apps doing this as seamlessly or synchronously as possible is beneficial.

Related to the local vendor module 20, the credit check module 16 uses a typical credit check API offering to take the local financial guidelines and legal regulations into account and get a decision as to whether or not a user should be approved for a credit check (i.e., a “yes” decision), denied/rejected for a credit check (i.e., a “no” decision), or if the outcome is not clear (i.e., a “maybe” decision). The simplest and most straightforward way to fully automate the credit check flow is to accept a customer who receive a “yes” credit check decision and grant them an automotive subscription, and to reject a customer who gets a “no” or “maybe” decision and decline to give them a subscription (e.g., an automobile subscription). That conservative approach protects the company from approving customers with unfavorable or hard-to-determine credit. This also preserves a simple and automated flow, but some valid business opportunity may be lost by rejecting all users who get a “maybe” decision, and it may annoy customers who are surprised or disappointed to be rejected. Thus, an improvement over this is to approve customers who get a “yes” decision and reject customers who get a “no” decision, and then the customers who get a “maybe” decision can be handled manually by the customer support organization in a totally manual way. This is a possible approach, since there can be a wide variety of reasons that a customer would get a “maybe” decision and in general the subsequent processing of such “maybe” decisions cannot be easily automated conventionally.

However, a better, innovative, approach is to initially treat a “no” or “reject” as a “soft reject” or “soft decline” (i.e., basically like a “maybe”). A second key aspect of this approach is how the customer support organization manually processes a “maybe” (or a “soft reject” that is initially treated as a “maybe”). The straightforward approach would be that once a credit check goes to the customer support organization for manual processing it stays with the customer support organization until it is completed. But in this new approach, depending on a variety of factors, the customer support organization, after taking whatever manual steps are needed, will decide whether to approve the credit check application (move to “yes”), reject the credit check application (move to “no”), or “restart” the credit check application. Note that by restarting the credit check application, the user is prompted (perhaps by email) to continue the automated web GUI (or mobile app) flow by redoing some aspects of the credit application in the GUI 12. Note that this cycle can continue multiple times if needed/appropriate. This is an improved flow for users in that now in some cases they can eventually get approved in some situations where they otherwise would not have gotten approved. This is also an improvement for the company in that if a user can qualify for a subscription after some adjustments, that business opportunity is not lost. Some situations where a manual customer support organization investigation can later lead to an approved credit check include:
(1) There was a mistake in correctly identifying a customer, a fraud alert was generated, or there is a typographical error in the social security number or other identifying information, such as the driver's license number, etc.
(2) The customer had frozen their credit check account, which resulted in a “no” or “reject”. If the customer support organization then tells the customer about this and the customer un-freezes their account then a re-run of the automated credit check can produce more valid results.
(3) If the customer under-reported their income, then this can be resolved by resubmitting that information in the GUI and redoing the automated credit check.
(4) If the customer does not qualify as an individual applicant, but might well qualify as a joint applicant (for example by adding a spouse or other relative), then the customer can resubmit in the GUI including the co-applicant information.
(5) In some cases, if a customer does not qualify for a certain subscription, the customer support organization can ask if the customer is interested in trying again for a less expensive subscription to see if they are qualified for that.
(6) In certain jurisdictions, if a customer does not qualify initially, sometimes the customer support organization can ask if the customer is willing to pay up front a certain number of months' worth of fees, and then try again in the GUI. In some situations that might result in a “yes” approval.

Note that anytime the customer support organization gets involved and makes a manual decision the flow is deemed to be paused or “asynchronous” until the customer support organization makes a decision on the customer credit application.

Note that an extension to this innovation could be that when a manual step is involved, instead of just trying to get a user to an approved “yes” decision, an effort could be made to instead maximize the business value of how to get a user to a “yes” decision (i.e., some “yes” scenarios might be better from a business perspective than others). Similarly, some intelligence could be applied to prevent certain scenarios from getting to a “yes” decision if that would reduce the business value. This soft reject flow could also be tailored based upon analytics, some other analysis of the customer and/or the automobile(s) being subscribed to, and/or analysis of big data based on the factors involved. The flow could also be dynamically adjusted based upon overall business conditions, factory or store inventories, the current workload of the customer support organization, and/or other external factors.

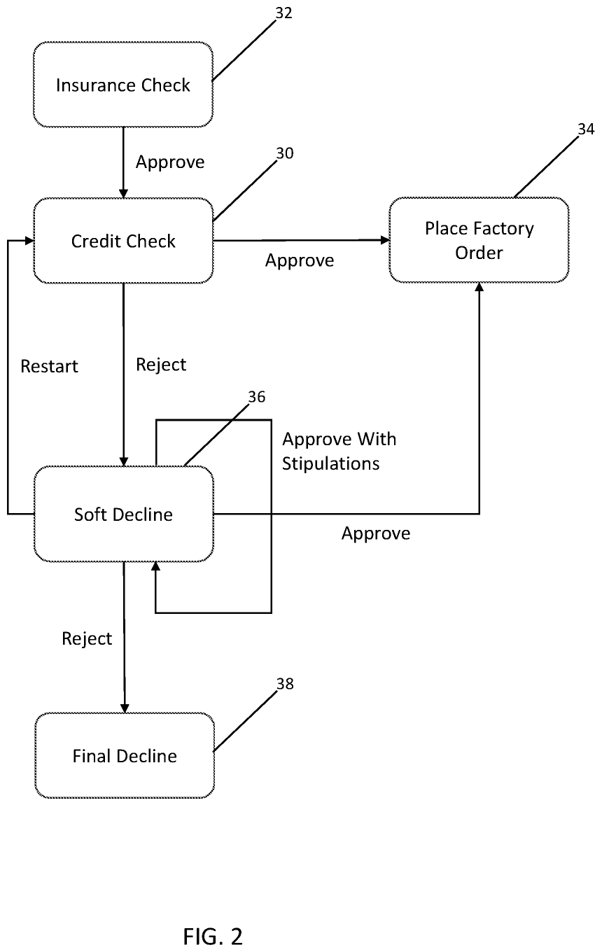

Referring now specifically to FIG. 2, in one exemplary embodiment, the credit check 30 is supplemented by an insurance approval 32, for example. A credit check approval by the customer support organization results in a factory order for the associated vehicle being placed 34. Here, a credit check rejection by the customer support organization is treated as a “soft decline” 36, which can then restart the credit check 30, result in an approval with stipulations, or, based on business considerations, result in an ultimate approval and factory order 34 or a “final decline” 38. Note that when we go to the restart credit check flow it may be after manually requesting the user to adjust their input. One example of this might be for the user to add a co-applicant with better credit and/or more income. Another example might be for the user to un-freeze their frozen credit check if the user has frozen credit checks to prevent credit reports being done. Another example might be if a user has initially under-reported their income, or over-reported their mortgage, rent, or other costs. Another example might be for the user to adjust some information provided if the initially reported information results in a fraud alert (for example it is not clear to the automated credit check if the user is in fact who the user claims to be).

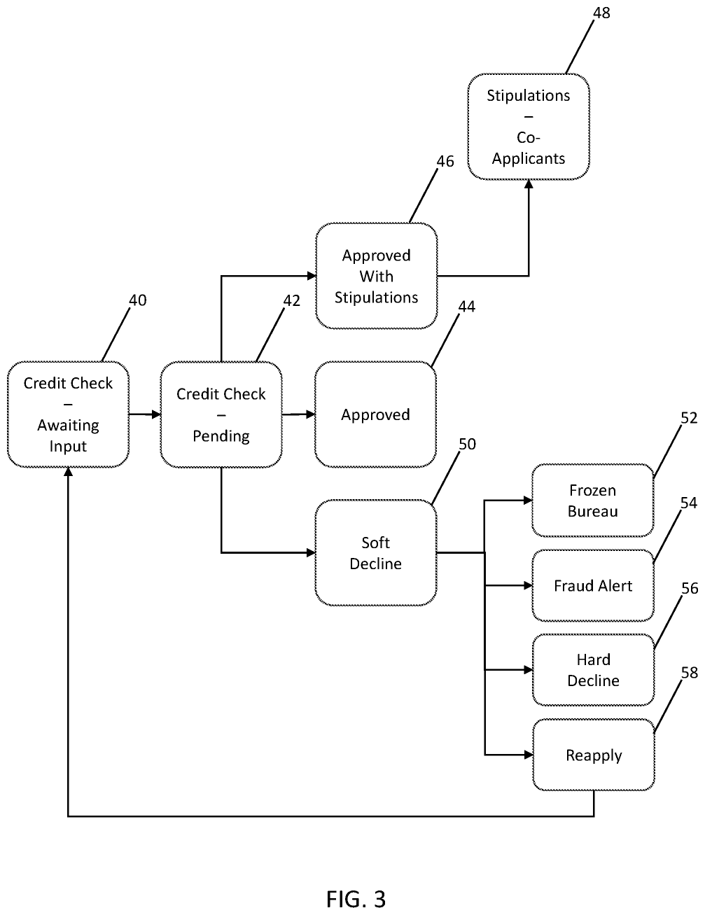

Referring now specifically to FIG. 3, in another exemplary embodiment, the credit check awaits relevant input 40 and, once everything is complete, the credit check is pending 42. Via the query of customer service organizations, the result is either an approval 44, an approval with stipulations 46, in which case the stipulations are displayed to the user 48, or a soft decline 50. Here, the soft decline 50 could be the result of a frozen bureau status 52, which could result in a corresponding email or alert being sent to the user in an attempt to unfreeze the bureau status. The soft decline 50 could also be the result of a fraud alert 54, which could result in a corresponding email or alert being sent to the user and an appropriate alert being sent to the credit bureau. The soft decline 50 could further result in a hard decline 56, which could result in a corresponding email or alert being sent to the user. The soft decline 50 could further result in a reapplication notification 58, which could result in a corresponding email or alert being sent to the user.

Note, in some jurisdictions, there could be an additional GUI screen or page (both in the Web UI and the mobile app), including a “bank details” page, which prompts users for the bank account name and identifiers. Note that this page is not presented to the customer until when/if the customer has their credit check approved successfully (with a “yes”). This “bank details” step also has an automated decision involved for approving or rejecting the credit application based upon the bank information. This could be expanded from a simple “yes” or “no” decision (or a simple “yes” or “maybe” decision) to include various different “maybe” scenarios. This could also be expanded to include some aspects of the “soft reject” methodology described above.

The goal is to not immediately reject all “no” decisions or “maybe” decisions, but to move a number, or percentage, of them to a “yes” decision to improve the business value. The theoretical goal is to iteratively move all credit check applications that initially get a “no” decision, or a “maybe” decision, along to a “yes” approved decision. There is a prioritized/ordered list of potential solutions, which could be prioritized/ranked according to potential business value. Those solutions with the highest potential business value would be ranked first, at the top of the list. Each of these potential solutions in the list would be tried in order, until a “yes” decision is achieved. Note that each of these potential solutions would be automated, there would be no manual interactions needed by the customer support organization. This reduces the cost of manual intervention, and increases customer satisfaction by generally giving synchronous decisions, more or less instant decisions.

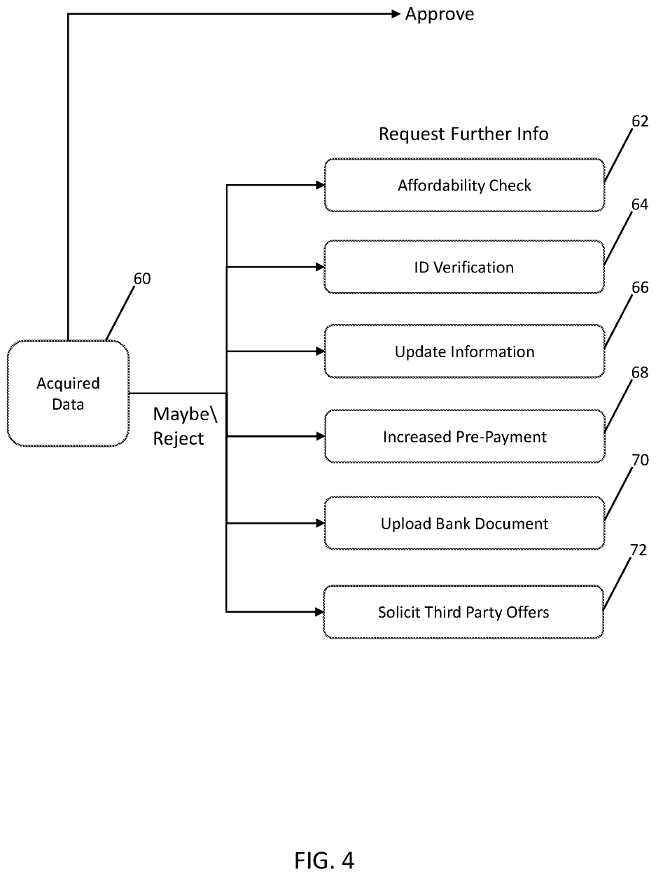

FIG. 4 illustrates that, if a credit check gets a “no” decision or a “maybe” decision, instead of going to manual processing by the customer support organization, the credit check may go into a new and different paradigm of totally automated credit check decision making. From the acquired data 60, there is a prioritized list of automated credit check operations. They are prioritized in order of business value. They are performed in order, until a “yes” result is achieved. Note that some operations might change the acquired data 60 (i.e., the customer data that the credit check is performed upon). In that scenario, that might change the order that the credit check operations are performed in—it might make the credit check go back to the first credit check operation in the prioritized list, or to move up to a certain position closer to the start of the prioritized list. Some examples of prioritized credit check operations, in order, might include:
A) ID Verification 64. Sometimes a credit check might fail due to the ID of the customer not being properly verified for some reason or additional customer information being required. There may be some automated ways to satisfy this. This could provide significant business value, as there might be a customer with high quality credit, but that customer needed their ID to be verified to determine that.
B) Increase customer pre-payment 68. If a customer has a credit rating that is almost good enough to qualify for credit, but not quite, then sometimes adding a pre-payment of a certain number of months' payment might enable to the customer to be approved with a “yes”.
C) “Sell” credit check opportunity to a third-party offering 72. That is, if a certain customer looks too risky to get a credit approval, it is very possible that an outside credit company may want to pay for the opportunity to provide credit to that customer. This might be less profitable than options, but could still provide some business value.

Note that while the theoretical goal might be to move all credit checks to a “yes” approval, there might still be some cases where a “no” still happens after trying various different kinds of credit checks. But these should be more rare than with other approaches.

Thus, the first embodiment described herein is basically making a manual asynchronous process automated and synchronous, but asynchronous when necessary without losing the overall automated feel. The second embodiment described herein is basically adding a “soft decline” concept to the first potential innovation. This allows for iteratively adding manual asynchronous processing, that in some cases could then put the credit check back into the credit check flow, which could then go back to manual asynchronous processing again or re-enter an automated flow again. The third embodiment is to provide all customers opportunities to digitally provide additional credit information or collateral for the credit check applications that initially get a “no” decision, or a “maybe” decision, to improve their profile until they get a “yes” approved decision. There would be a prioritized/ordered list of potential solutions, which would be automatically and dynamically introduced to customers based on weaknesses in their credit profile. Those solutions with the highest potential business value (towards enhancing credit profile) would be determined for each customer and presented. This process continues to iterate until the credit profile or collateral is sufficient to approve the credit profile.

The idea here is to have a series or list of automated credit assessment operations, or processes that can be performed, in any sequence, upon the assessment of the credit check applications current information that could factor in a large number of factors or situations. These could dramatically improve the business efficiency and business value of the customer subscriptions and their accompanying credit checks. Some of these would be automated by some operations that can be done manually today in manual credit assessment operations. But some of these would go far beyond that based on factors that could not be done manually.

Whether each of this credit assessment operations, or processes, is used in the flow or not could vary. And the order that they are performed in could vary as well. These could be adjusted based upon business conditions, changes in priorities, and data feedback. Some examples of credit assessment operations, not in prioritized order, might include:
A) Affordability check 62. This is basically comparing the cost of the subscription to the overall income of the applicant. Based upon this threshold or ratio some decisions can be made.
B) ID Verification or Enhanced ID Verification 64. Sometimes it is very clear that the information for the correct applicant has been received. And sometimes it is not clear. And sometimes it is only mostly clear. For example, if we have information about John Doe on Delaware Ave, in Buffalo, N.Y., it might not be 100% clear if it is the same John Doe from Buffalo who is doing the credit check. People can move to different addresses. Or even if they have not moved, they can specify the address in a slightly different manner. So, the less confidence we have in the ID Verification, the less likely we are to approve the credit check overall. And, the less confidence we have in the ID Verification, the more likely that a credit decision will have to be made manually.
C) Increase customer collateral (down-payment, pre-payment, or other) 68. If a customer is a borderline credit risk, adding or increasing the pre-payment might make the difference in the decision as to whether to approve or deny and make it so that the credit check can be approved.
D) Access to financial data (including bank, income, and financial documents) 70.
   a. The customer could provide login access to their bank account, and then banking-related data including income and expenses could be extracted/consumed automatically. This would not only be faster than traditional manual approaches but would also provide more accurate and more complete data, which would increase the effectiveness of the credit check.
   b. The customer could also provide digitalized versions (scans, pictures) of bank documents.
   c. The customer could also be asked to self-report financial information like income, mortgage payments, employment status, housing status, etc.
E) Solicit third-party offering 72. This would involve giving third parties or partners the opportunity to provide credit to customers. Typically, this might involve a partner giving us some payment or referral fee for the opportunity to do business with customers that might not meet high/conservative business thresholds.
F) Offering Counter Approval Amounts: If the customer cannot be approved for the specific asset (such as a vehicle), but could be approved for a lower amount, we could offer them to choose a lower priced option (e.g., used or lower priced model).
G) Probationary Lending Offer: If a customer exposes a weakness in our dataset where we cannot make an accurate assessment, the service would be able to offer a probationary lending offer strategically to be able to collect more data should the situation occur again.
   The above examples, in general, could, at least in theory, be performed manually. Doing them in an automated manner can produce large business advantages and efficiency. It should be noted that “vending out” a credit application to a third party is good in that a conservative vendor may reject a credit application while a more liberal vendor may be able to effectively take it on and monetize it.

Some other examples, below, might not practically be done manually, and/or could not have the parameters adjusted dynamically by manual handling:
H) The credit check acceptance rate can be dynamically adjusted based on inventory of certain kinds of cars. For example, if inventory of a certain car model is low an algorithm may be implemented to increase the requirements—and only accept higher-quality applicants. More often and more practically, if the inventory of a certain car model is high then the algorithms can be adjusted to approve a higher number of credit check applicants. This could be further refined based upon projected future inventories based on dynamic in-production data.
I) The credit check acceptance rate/criteria, etc., can be dynamically adjusted based on business needs. For example, if a manufacturer desires more sales or subscriptions at the end of the quarter to improve quarterly results then that could be factored in.
J) The credit check acceptance rate/criteria, etc., can be dynamically adjusted based on business needs including exchange rates, tariffs and/or tax changes, or other market conditions.
K) The credit check acceptance rate/criteria, etc., can be dynamically adjusted based on dynamic issues with the store(s) (such as car dealer(s)) where the products or product subscriptions are picked up from. Or, better yet, based on the location of the product.
L) The credit check acceptance rate/criteria, etc., can be dynamically adjusted based on reputation-based assessments of the car vendor and/or the customer. This actually would probably apply more to the reputations of third-party sites or partners.
M) Machine-learning (ML) can be used to improve some of these processes based upon data from customers, and/or based upon business knowledge and/or trends in general. This can be done on the customer service organization side. This might also more naturally occur within FICO or an analogous partner (such as DealerTrack, Equifax, Experian, etc.) who have a tremendous amount of data. Thus, ML could be applied on the customer service organization and/or third party partner side.

Note that these new ideas (G-L and beyond in the foregoing list) can be used to do more than alter the number and quality of credit check applications that are accepted or rejected. These kinds of ideas and techniques can be combined with the principles mentioned in A-F above to dynamically, in an automated manner, improve business process flows that are implied in steps A-F including giving the customers the opportunity to upgrade or downgrade. These could also be used to improve when and how we “sell” the credit opportunities to partners. These could also be used to dynamically adjust and improve down payment and other customer payment scenarios, bank processes, and how we gather and update and refine customer information including but not limited to address and employment and financial information.

The above are just a subset of the types of factors that can be factored into the decision-making. Some of these are most naturally accomplished using big data and/or artificial intelligence (AI) to dynamically achieve the best results based on a wide variety of factors. Also, the number of factors, the order, and the priority of all of these factors can be dynamically changed based on factors including but not limited to those described above, and also using big data, analytics, machine learning, and/or artificial intelligence. This gives a great deal of power and flexibility in improving and optimizing business processing. A key point here is that these credit assessment operations do not all need to be done, and the order and priority will be dynamically determined based on the customer's credit profile. These credit assessment operations can be mixed and matched dynamically and programmatically.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) a tangible computer-readable storage medium that is non-transitory or (2) a communication medium, such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), electrically erasable- programmable read-only memory (EEPROM), compact disc read-only memory (CD-ROM) or other optical disc storage, magnetic disk storage, or other magnetic storage devices, flash memory, or any other medium that can be used to store desired program code in the form of instructions or data structures and that can be accessed by a computer, including, preferably, cloud-based storage. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared (IR), radio frequency (RF), and microwave, then the coaxial cable, fiber optic cable, twisted pair, DSL, or wireless technologies, such as IR, RF, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above are included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor”, as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Although the present disclosure is illustrated and described herein with reference to preferred embodiments and specific examples thereof, it will be readily apparent to persons of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes.

1. A method of enabling a user to subscribe to, lease, or purchase an asset or asset service using an application, the method comprising:
receiving user and asset information via the application;
receiving credit check information via the application;
based on the user, asset, and credit check information, via a customer service organization link, designating the user as one status of “approved”, “denied”, and “maybe”;
responsive to the “denied” or “maybe” status designation, requesting further user information via the application or manually or automatically taking a dynamic rule action to change the status designation to the “approved” status designation based on additional user information received responsive to the request or the dynamic rule action taken; and
notifying the user of the status designation via the application;
wherein either of the designating the user as the one status of “approved”, “denied”, and “maybe” and the manually or automatically taking the dynamic rule action to change the status designation to the “approved” status designation occur within a predetermined period of time or else an electronic message is sent to a mobile device of the user when complete.

2. The method of claim 1, wherein the user information comprises one or more of personal identification information, insurance information, and banking information.

3. The method of claim 1, wherein the credit check information comprises one or more of financial information and jurisdiction information.

4. The method of claim 1, wherein requesting the further user information via the application comprises one or more of requesting further user identification information, requesting further user financial information, and requesting access to one or more user financial accounts.

5. The method of claim 1, wherein manually or automatically taking the rule action comprises one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination.

6. The method of claim 1, wherein the designating step is monitored using a visual progress indicator displayed in the application.

7. A non-transitory computer-readable medium stored in a memory and executed by a processor to perform steps for enabling a user to subscribe to, lease, or purchase an asset or asset service using an application, the steps comprising:
receiving user and asset information via the application;
receiving credit check information via the application;
based on the user, asset, and credit check information, via a customer service organization link, designating the user as one status of “approved”, “denied”, and “maybe”;
responsive to the “denied” or “maybe” status designation, requesting further user information via the application or manually or automatically taking a dynamic rule action to change the status designation to the “approved” status designation based on additional user information received responsive to the request or the dynamic rule action taken; and
notifying the user of the status designation via the application;
wherein either of the designating the user as the one status of “approved”, “denied”, and “maybe” and the manually or automatically taking the dynamic rule action to change the status designation to the “approved” status designation occur within a predetermined period of time or else an electronic message is sent to a mobile device of the user when complete.

8. The non-transitory computer-readable medium of claim 7, wherein the user information comprises one or more of personal identification information, insurance information, and banking information.

9. The non-transitory computer-readable medium of claim 7, wherein the credit check information comprises one or more of financial information and jurisdiction information.

10. The non-transitory computer-readable medium of claim 7, wherein requesting the further user information via the application comprises one or more of requesting further user identification information, requesting further user financial information, and requesting access to one or more user financial accounts.

11. The non-transitory computer-readable medium of claim 7, wherein manually or automatically taking the rule action comprises one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination.

12. The non-transitory computer-readable medium of claim 7, wherein the designating step is monitored using a visual progress indicator displayed in the application.

13. A system for enabling a user to subscribe to, lease, or purchase an asset or asset service using an application, the system comprising:
a processor;
memory storing a subscription module comprising instructions executed by the processor operable for receiving user and asset information via the application;
memory storing a credit check module comprising instructions executed by the processor operable for receiving credit check information via the application;
a customer service organization link operable for, based on the user, asset, and credit check information, designating the user as one status of “approved”, “denied”, and “maybe” and
responsive to the “denied” or “maybe” status designation, requesting further user information via the application or manually or automatically taking a dynamic rule action to change the status designation to the “approved” status designation based on additional user information received responsive to the request or the dynamic rule action taken;
a graphical user interface operable for notifying the user of the status designation via the application; and
memory storing instructions executed by the processor to ensure that either of the designating the user as the one status of “approved”, “denied”, and “maybe” and the manually or automatically taking the dynamic rule action to change the status designation to the “approved” status designation occur within a predetermined period of time or else sending an electronic message to a mobile device of the user when complete.

14. The system of claim 13, wherein the user information comprises one or more of personal identification information, insurance information, and banking information.

15. The system of claim 13, wherein the credit check information comprises one or more of financial information and jurisdiction information.

16. The system of claim 13, wherein requesting the further user information via the application comprises one or more of requesting further user identification information, requesting further user financial information, and requesting access to one or more user financial accounts.

17. The system of claim 13, wherein manually or automatically taking the rule action comprises one or more of applying a cost-to-income threshold to the received credit check information; presenting an increased user collateral requirement to the user; soliciting a third party lender with the received credit check information; issuing a probationary “approved” status or an “approved” status with stipulations; issuing an “approved” status based on asset inventory data, business considerations, and/or geographic location; and applying a machine learning (ML) algorithm to the credit check information to reach a subsequent status determination.

18. The system of claim 13, wherein the designating step is monitored using a visual progress indicator displayed in the application.
